(19) United States
(12) Patent Application Publication
(10) Pub. No.: US 2004/0251592 A1
(43) Pub. Date: Dec. 16, 2004

(54) Sheet media input structure for a sheet media processing device

(76) Inventors: Tom Ruhe, La Center, WA (US); Jiangxiao Mo, Vancouver, WA (US); Scott Smith, Vancouver, WA (US); Gary Miller, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 10/463,484

(22) Filed: Jun. 16, 2003

(51) Int. Cl. B65H 3/06; B65H 3/46; B65H 9/04; B41J 13/00; B41J 13/26

(52) U.S. Cl. 271/109; 271/121; 271/245; 347/104

(57) ABSTRACT

In one embodiment, a sheet media input structure for a printer or other sheet media processing device comprises a sheet media supporting surface and a moveable face positioned downstream along a media path from the supporting surface. The face is moveable between a first position in which the face protrudes into the media path to block a leading edge of media sheets supported on the supporting surface and a second position in which the face does not protrude into the media path and media sheets are free to move from the supporting surface along the media path past the face. In one embodiment, the face pivots between the first and second positions. In another embodiment, the face rotates in a plane between the first and second positions.

### FIELD OF THE INVENTION

The invention relates to a sheet media input structure for printers and other sheet media processing devices.

### BACKGROUND

In many printers, individual sheets of paper or other print media are fed into the printer off the top of a stack of sheets held in a tray. Typically, a pick roller is rotated against the top sheet to slide the top sheet off the stack and into a set of feed rollers that feed the sheet into the print engine. The friction between sheets in the stack sometimes causes the top two or three sheets in the stack to stick together as the top sheet is picked from the stack. The next-to-top sheets must be separated from the top sheet to avoid feeding multiple sheets into the print engine at the same time.

In one conventional input structure, the next-to-top sheets are separated from the top sheet by driving the sheets against an angled wall positioned at the front of the media input tray. This separation wall also functions as a load stop to prevent the user from pushing media too far into the printer when a media stack is loaded into the tray. Since the wall is angled, however, it is comparatively easy for the user to push the stack partially up the separation wall and too far into the printer, which prevents effective sheet separation.

In some printers, an elastomeric pad is embedded in the separation wall to make it more difficult for a user to load the media stack too far into the printer. The compressibility and high surface friction of the pad create a desirable increase in the resistance to the media stack during loading. Unfortunately, a pad that creates enough resistance to function as an effective load stop can also create too much resistance to the top sheet picked from the stack and pushed up the separation wall along the pad. The present invention was developed in an effort to balance the need for a higher resistance load stop with the need for a lower resistance during media picking.

### DESCRIPTION OF THE DRAWINGS

FIG. 1 is a perspective view of an inkjet printer.

FIG. 2 is a perspective view of an inkjet printer such as the one shown in FIG. 1 with the cover and other parts of the housing removed.

FIG. 3 is a side elevation and partial section view of an inkjet printer such as the one shown in FIG. 2 with a conventional media input structure.

FIG. 4 is a perspective view showing in more detail the media input structure of the printer of FIG. 3.

FIG. 5 is a side elevation and partial section view of an inkjet printer such as the one shown in FIG. 2 with a media input structure constructed according to one embodiment of the invention.

FIG. 6 is a perspective view showing the media input structure of FIG. 5.

FIGS. 7-10 are side elevation and partial section views showing loading a stack of media sheets into the printer of FIG. 5 and then picking the top sheet from the stack.

FIG. 11 is a perspective detail view of a linkage for moving the load stop feature of the input structure depicted in FIGS. 5-10.

FIG. 12 is a side elevation detail view of the linkage of FIG. 11.

FIG. 13 is a side elevation and partial section view of an inkjet printer such as the one shown in FIG. 2 with a media input structure constructed according to a second embodiment of the invention.

FIG. 14 is a perspective view showing the media input structure of FIG. 13.

FIGS. 15-18 are side elevation and partial section views showing loading a stack of media sheets into the printer of FIG. 13 and then picking the top sheet from the stack.

FIGS. 19 and 20 are plan views showing the actuator and linkage for the load stop feature of the input structure depicted in FIGS. 13-18. In FIG. 18, the stop is in the stack blocking position. In FIG. 20, the stop is retracted away from the blocking position.

FIG. 21 is a perspective detail view of the actuator and linkage for the load stop feature of the input structure depicted in FIGS. 13-18.

### DETAILED DESCRIPTION

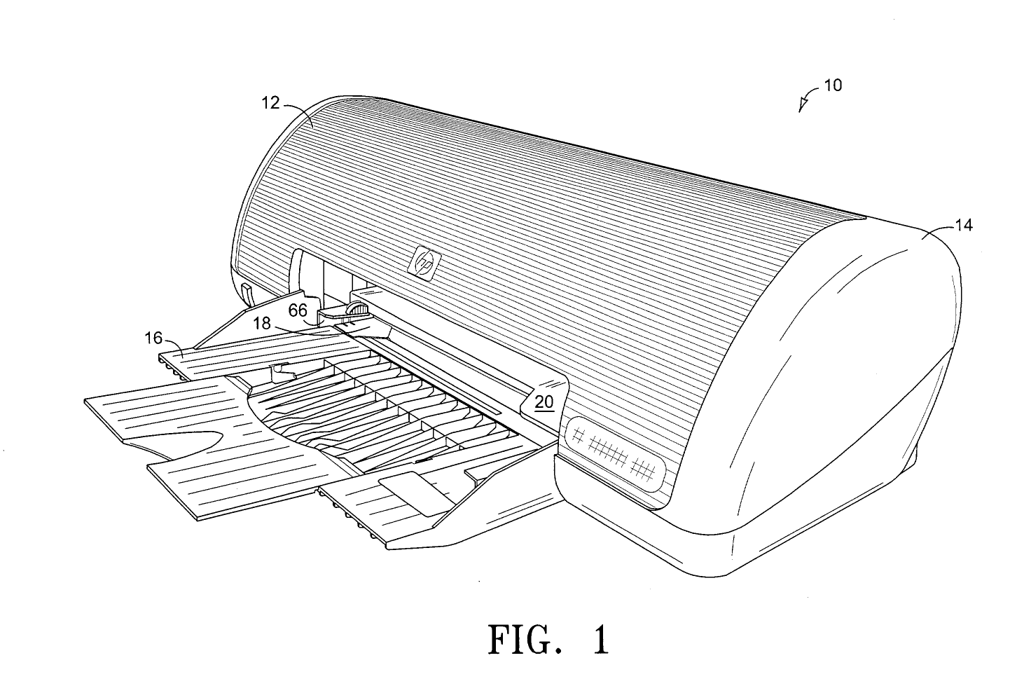

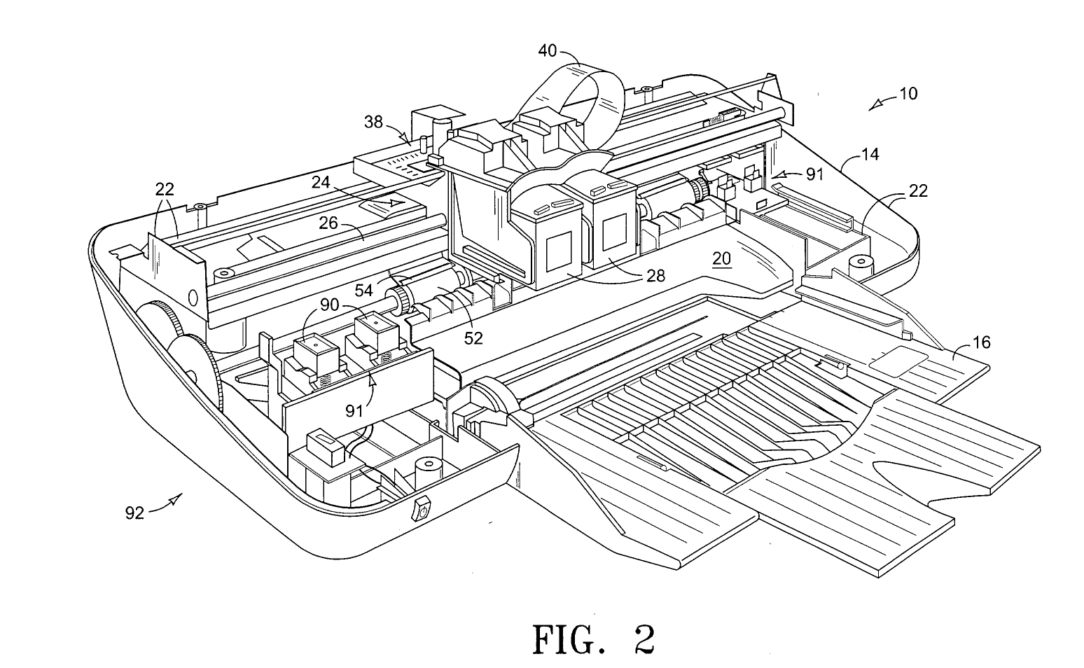

Embodiments of the invention will be described with reference to the ink-jet printer shown in FIGS. 1 and 2. The invention, however, is not limited to use with inkjet printers. Embodiments of the invention may be implemented in any printer or other sheet media processing device in which it is necessary or desirable to use a movable feature to block the media path to help prevent media sheets from being loaded too far into the device. While the invention is not limited to use with ink-jet printers, it is expected that various embodiments of the invention will be particularly useful in printers with a U-shaped media path typical of many inkjet printers in which the print media is fed at a steep angle from a horizontal tray.

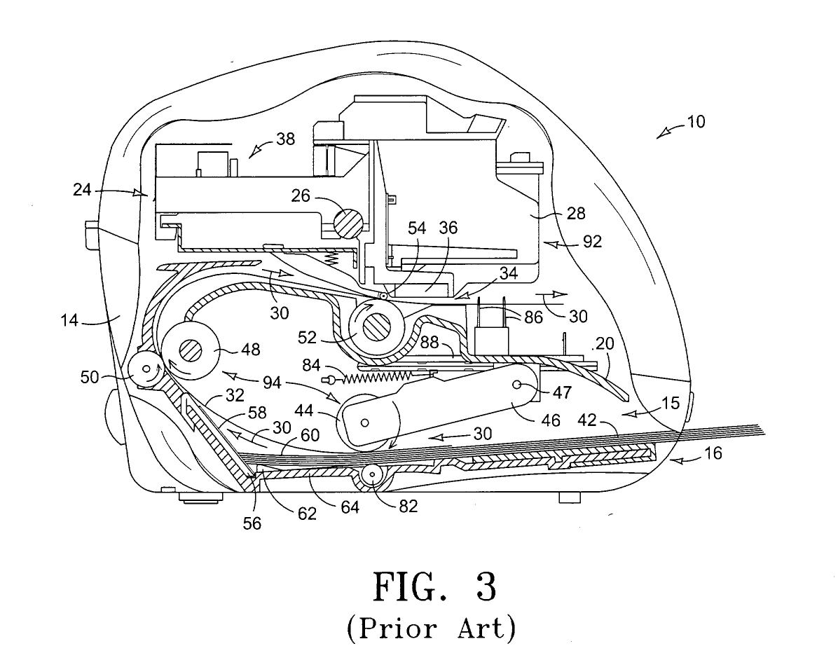

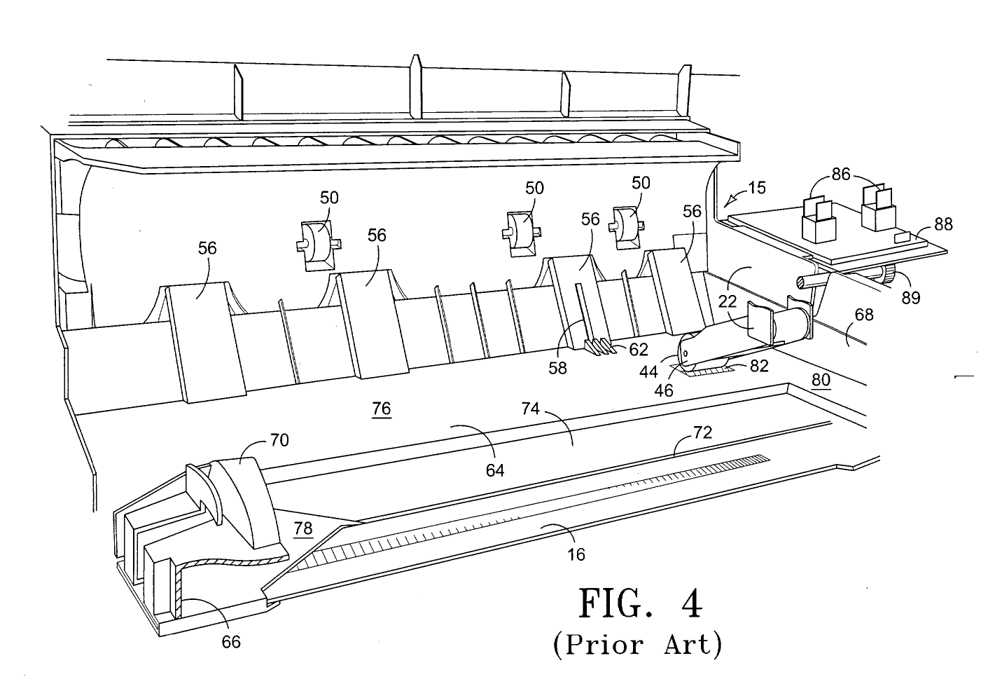

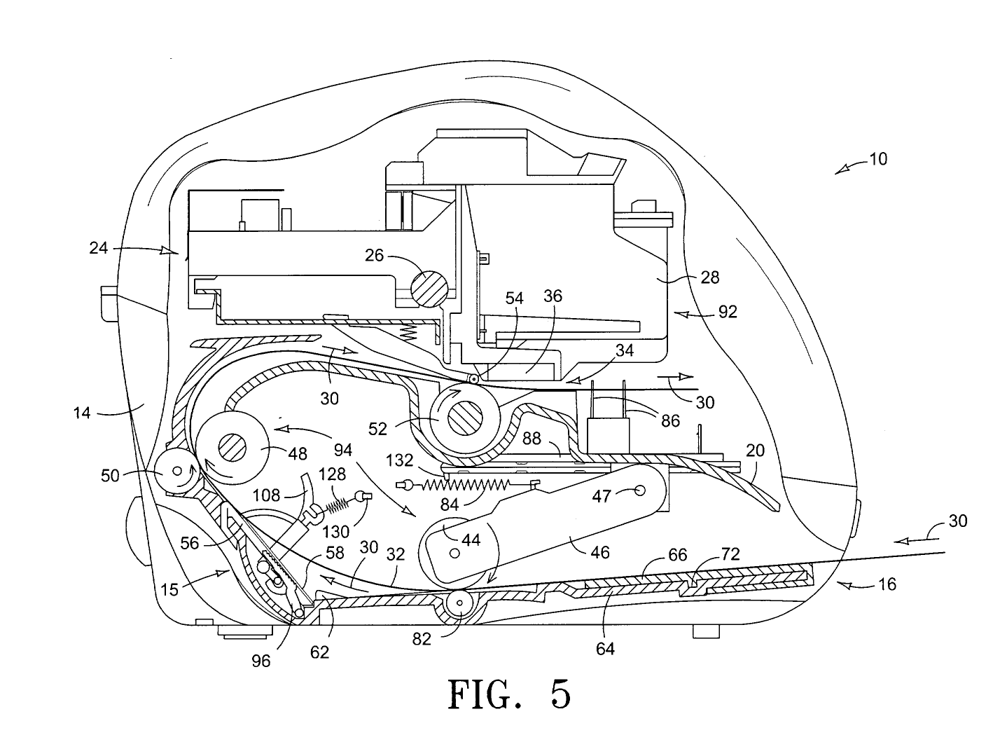

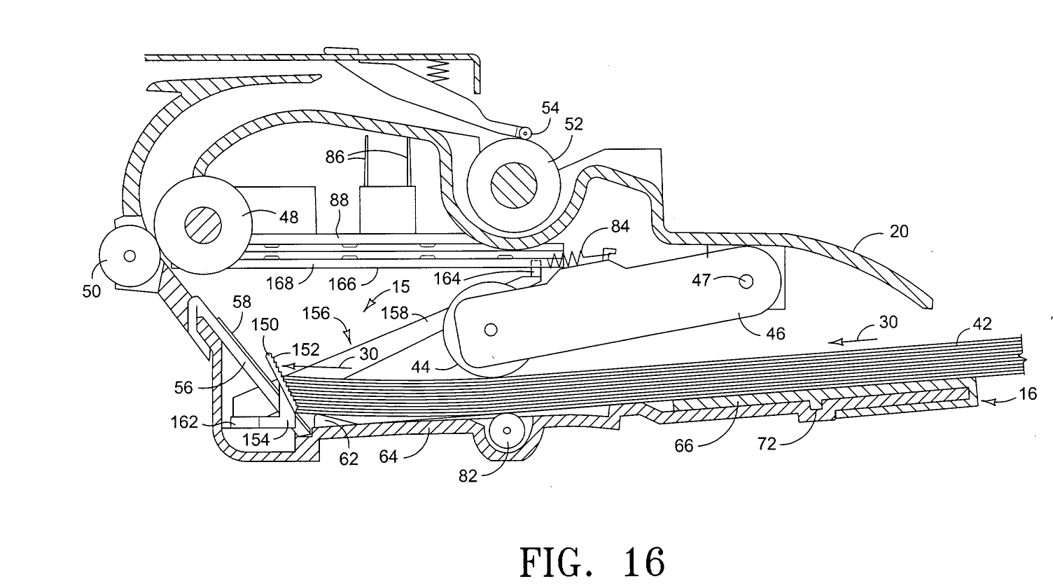

FIG. 1 illustrates an inkjet printer 10. FIG. 2 shows inkjet printer 10 with cover 12 (FIG. 1) and other parts of housing 14 removed. FIG. 3 is a side elevation and partial section view of an inkjet printer 10 such as the one shown in FIGS. 1 and 2 with a conventional input structure, designated generally by reference number 15. FIG. 4 is a perspective view of a conventional input structure 15 and components of the media sheet pick mechanism used in printer 10. A conventional input structure is discussed first, along with the other components of printer 10, to better distinguish the various embodiments of the input structure of the present invention. FIGS. 3 and 4 show a conventional input structure. FIGS. 5-11 and 12-20 show two embodiments of a new input structure.

Referring first to FIGS. 1-3, printer 10 includes a cover 12 and a housing 14. A sheet media tray 16 is positioned at the bottom of printer 10 along an opening 18 in housing 14. Paper or other print media sheets 32 (FIG. 3) are stacked in tray 16 for input to printer 10 and printed sheets are output back through opening 18 over tray 16. A supporting surface 20 helps suspend the trailing edge of the printed sheets over tray 16.

Printer 10 includes a chassis 22 that supports the operative components of printer 10. Chassis 22 represents generally those parts of housing 14 along with other structurally stable elements in printer 10 that support the operative components of printer 10. A printhead carriage 24 is driven back and forth along a guide rail 26 mounted to chassis 22. Any suitable drive mechanism may be used to move carriage 24. A reversing motor (not shown) coupled to carriage 24 through a belt and pulley system (not shown), for example, is one carriage drive mechanism commonly used in inkjet printers.

Carriage 24 has stalls for holding one or more printheads 28. In the printer shown in FIGS. 1-3, carriage 24 carries two printheads 28—one printhead containing color ink for color printing and one printhead containing black ink for monochrome printing. Printheads 28 are also commonly referred to as print cartridges or ink cartridges. As best seen in FIG. 3, printheads 28 are positioned along media path 30 such that each sheet of print media 32 passes directly under printheads 28 at print zone 34. The bottom 36 of each printhead 28, which faces media sheet 32, includes an array of nozzles through which drops of ink are ejected onto media sheet 32.

An electronic printer controller 38 receives print data from a computer, scanner, digital camera or other image generating device. Controller 38 controls the movement of carriage 24 back and forth across media sheet 32 and the advance of media sheet 32 along media path 30. Printer controller 38 is also electrically connected to printheads 28 through, for example, a flexible ribbon cable 40. As carriage 24 carries printheads 28 across media sheet 32, printer controller 38 selectively activates ink ejection elements in printheads 28 according to the print data to eject ink drops through the nozzles onto media sheet 32. By combining the movement of carriage 24 across media sheet 32 with the movement of sheet 32 along media path 30, controller 38 causes printheads 28 to eject ink onto media sheet 32 to form the desired print image.

Referring now also to FIG. 4, top sheet 32 is “picked” from a stack 42 of media sheets in tray 16 and fed along media path 30. A pick roller 44 mounted on a swing arm 46 rests on top sheet 32. When a sheet is needed for printing, pick roller 44 is driven clockwise at the direction of controller 38 to grab top sheet 32 and feed it along media path 30 toward transport roller 48. Transport roller 48 bears against idler roller 50 to form a nip that moves sheet 32 along toward output roller 52. Output roller 52 bears against idler arm 54 to form a nip that moves sheet 32 onto sheet output supporting surface 20.

Each sheet 32 is guided from tray 16 toward transport roller 48 along guide ramps 56. Guide ramps 56 also function as angled separation walls that help prevent any next-to-top sheets carried along with top sheet 32 from moving into the transport roller nip. One or more guide ramps 56 may be fitted with a separator pad 58 if necessary or desirable to improve sheet separation. Separator pad 58 is typically constructed as an elastomeric strip that protrudes from the face of ramp 56. The force of pick roller 44 on top sheet 32 is sufficient to overcome the resistance of separator pad 58 while the next-to-top sheet 60, which is dragged along with only a much smaller sheet-to-sheet friction force, will be stopped by pad 58. That is to say, pad 58 separates next-to-top sheet 60 from top sheet 32. A stack ramp 62 is also sometimes provided to elevate the leading edge of sheets in the stack 42 to reduce the force needed to feed top sheet 32 past separator pad 58.

Media tray 16 includes a base panel 64 extending between sidewalls 66 and 68. Media tray 16 typically includes a mechanism to adjust the width of the tray to accommodate different width media. In the printer 10 illustrated in the figures, left sidewall 66 is integral to a slider 70 that slides along a slot 72 in a recess 74 in base panel 64 to adjust for differing width media. Base panel 64 and slider 70 define media support surfaces 76, 78 and 80.

Swing arm 46 is mounted to chassis 22 at a swing arm pivot 47 located upstream and above pick roller 44 such that pick roller 44 swings down counter-clockwise against stack 42. An idler roller 82 is recessed into base panel 64 directly below pick roller 44. When tray 16 is empty, pick roller 44 rests on idler roller 82 as shown in FIG. 4. In the event pick roller 44 is activated when tray 16 is empty, pick roller 44 will turn on idler roller 82 and, therefore, avoid any damage to pick roller 44 or other pick mechanism components. A biasing spring 84 urges swing arm 46 down to maintain contact between pick roller 44 and top sheet 32 in stack 42.

Wipers 86 and sled 88 are positioned at the right side of printer 10 near the end of travel of carriage 24. Wipers 86 wipe the exposed surfaces of the nozzle array on each printhead 28 to help keep those surfaces clear of ink residue and other debris that may accumulate on the nozzles. Wipers 86 are carried by a sled 88 that travels back and forth in a direction perpendicular to the direction of travel of carriage 24. Sled 88 is typically driven by a pinion gear 89 (FIG. 4) engaging a rack (not shown) in the undercarriage of sled 88. At the beginning of each printing operation, carriage 24 is driven to the right side position over wipers 86. Wipers 86 are then driven from a rearward resting position behind printheads 28 forward across the exposed surfaces of the nozzle array on the bottom of each printhead 28. After printing, carriage 24 is again driven to the right to position printheads 28 over wipers 86. Wipers 86 are then driven rearward across the bottom of each printhead 28 to their original resting position behind printheads 28, until the next printing operation. There may be multiple passes of wipers 86 across printheads 28 to help assure proper cleaning. At the end of the printing operation, carriage 24 is driven back across to the left to position printheads 28 over storage caps 90 where they will rest until the next printing operation.

Carriage 24 and printheads 28 along with other hardware components necessary to deliver ink to the print media are referred to collectively as print engine 92. Rollers 44/82, 48/50 and 52/54 along with other hardware components necessary to transport the print media through printer 10 are referred to collectively as pick/feed mechanism 94. Wipers 86, sled 88 and caps 90 are all components of an assembly commonly referred to as a printhead service station 91. Controller 38 includes the programming, processor and associated memory and electronic circuitry necessary to control print engine 92, pick/feed mechanism 94, service station 91 and the other operative components of printer 10.

The components of printer 10 described above are all conventional components well known to those skilled in the art of inkjet printing. Therefore, additional structural and operational details of these components are omitted except as noted below for input structure 15.

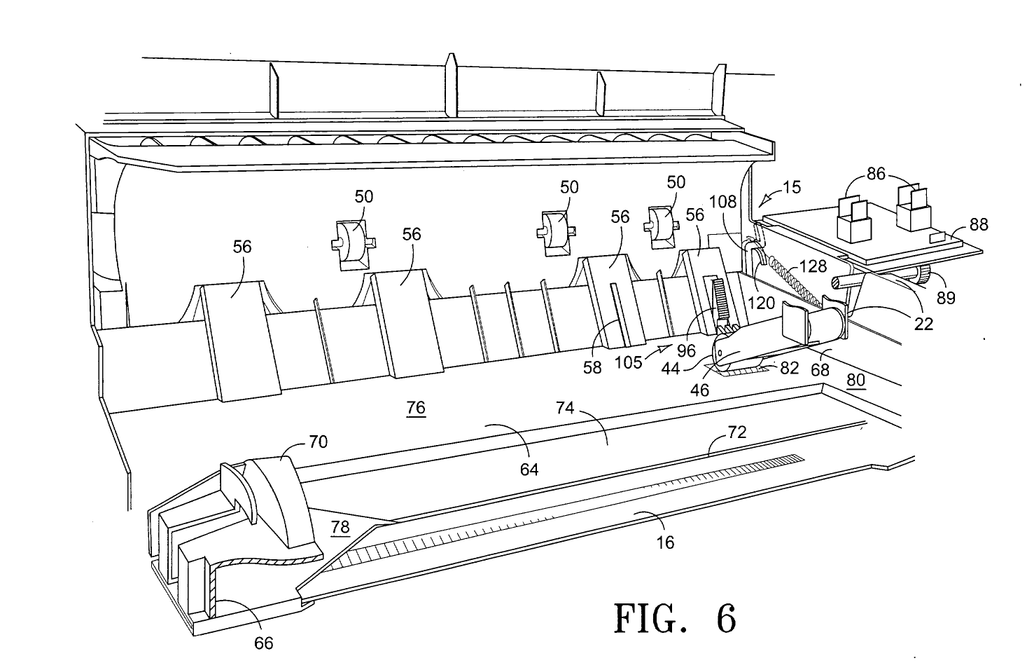

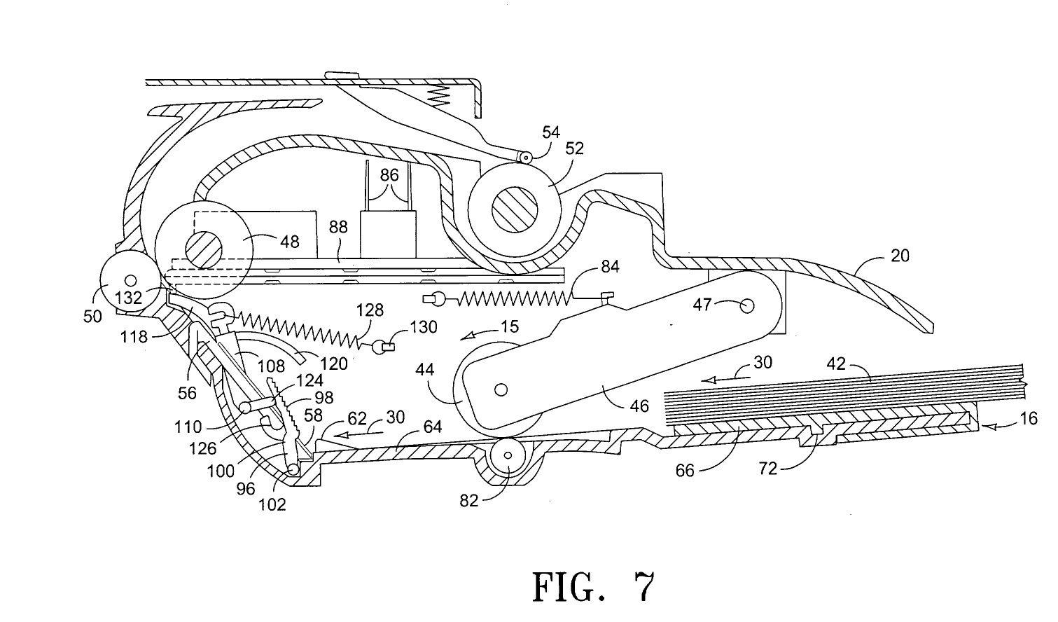

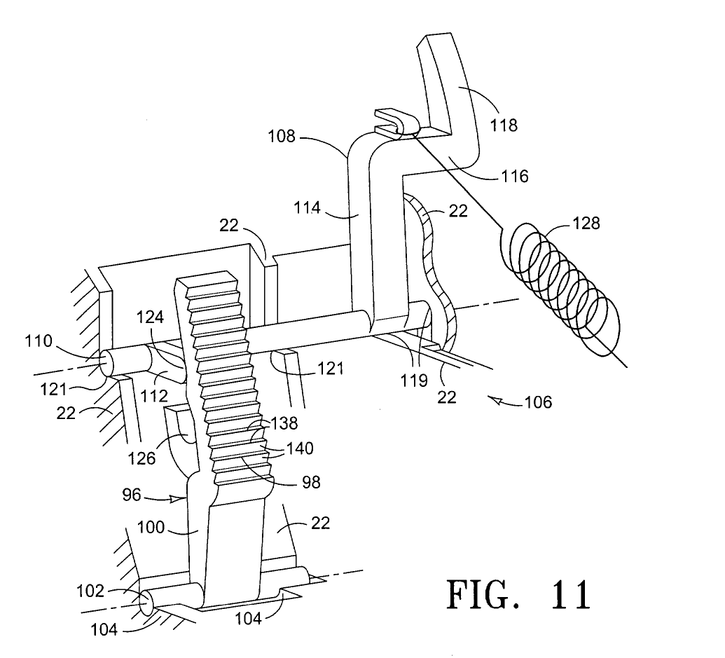

One embodiment of the invention will now be described with reference to FIGS. 5-11. FIG. 5 is a side elevation and partial section view of a printer 10 incorporating an input structure 15 constructed according to a first embodiment of the invention. FIG. 6 is a perspective view of input structure 15 and components of the media sheet pick/feed mechanism 94. FIGS. 7-10 are side elevation and partial section views showing the operation of input structure 15. FIG. 11 is a perspective detail view of the load stop feature and actuator linkage of the input structure depicted in FIGS. 5-10.

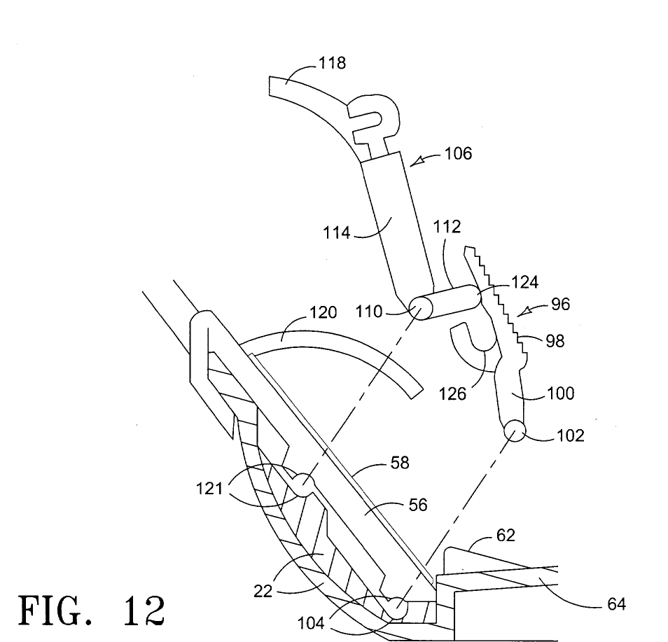

Referring to FIGS. 5-7 and 11-12, input structure 15 includes media tray 16, ramps/walls 56, separator pad 58 and a load stop 96. Load stop 96 is housed in one of the guide ramps 56. Load stop 96 includes a face 98, a body 100 and a horizontally oriented axle 102. As shown in FIGS. 11 and 12, axle 102 is supported at each end in a hub 104 formed in chassis 22 and ramp 56 (FIG. 12), housing 14 or some other structurally stable component at the forward base area 105 of input structure 15. A linkage 106 connects load stop 96 to an actuator which, in this embodiment, is wiper sled 88. As best seen in FIG. 11, linkage 106 includes a lever arm 108, a horizontally oriented axle 110 and a connecting arm 112. Lever arm 108 extends from axle 110 at a generally vertical lower part 114 up through a generally horizontal middle part 116 into the path of wiper sled 88 at a generally vertical upper part 118. As shown in FIGS. 11 and 12, axle 110 is supported at lever arm 108 in a hub 119 formed in chassis 22 below the rear travel area of wiper sled 88 and behind load stop 96 in hubs 121 formed in chassis 22 and ramp 56 (FIG. 12). Lever arm middle part 116 fits through a curved slot 120 in chassis 22 at the right side of input structure 15. Connecting arm 112 extends from axle 110 to load stop 96. The free end 124 of connecting arm rides in a saddle 126 in body 100 of load stop 96. A biasing spring 128 extends between lever arm middle part 116 forward to an attachment point 130 (FIG. 5) on chassis 22 to bias lever arm 108 toward a forward position. A contact tab 132 (FIG. 5) is formed at the rear of wiper sled 88 to engage upper part 118 of lever arm 108.

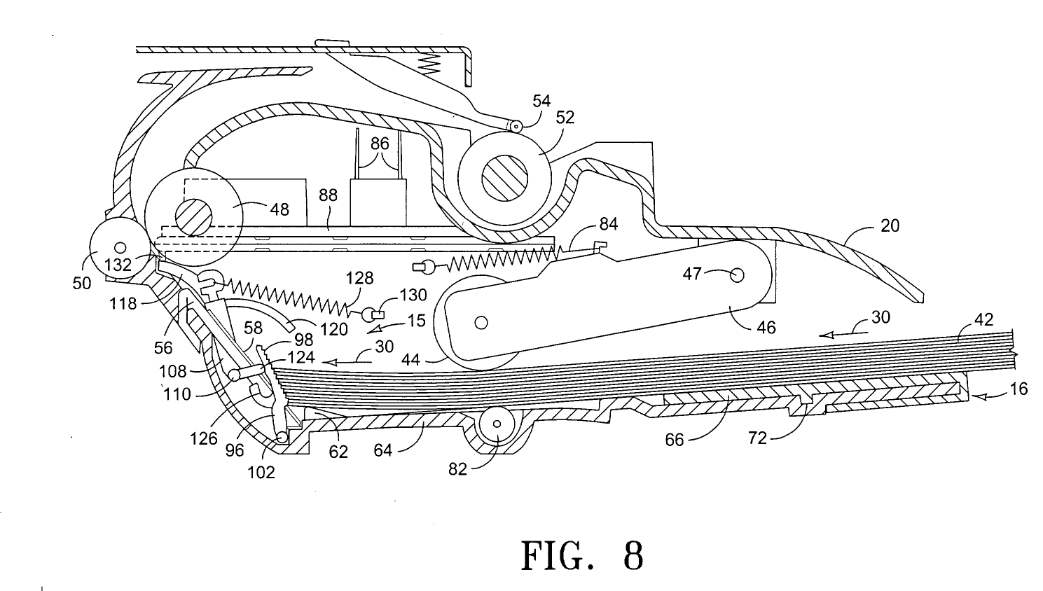

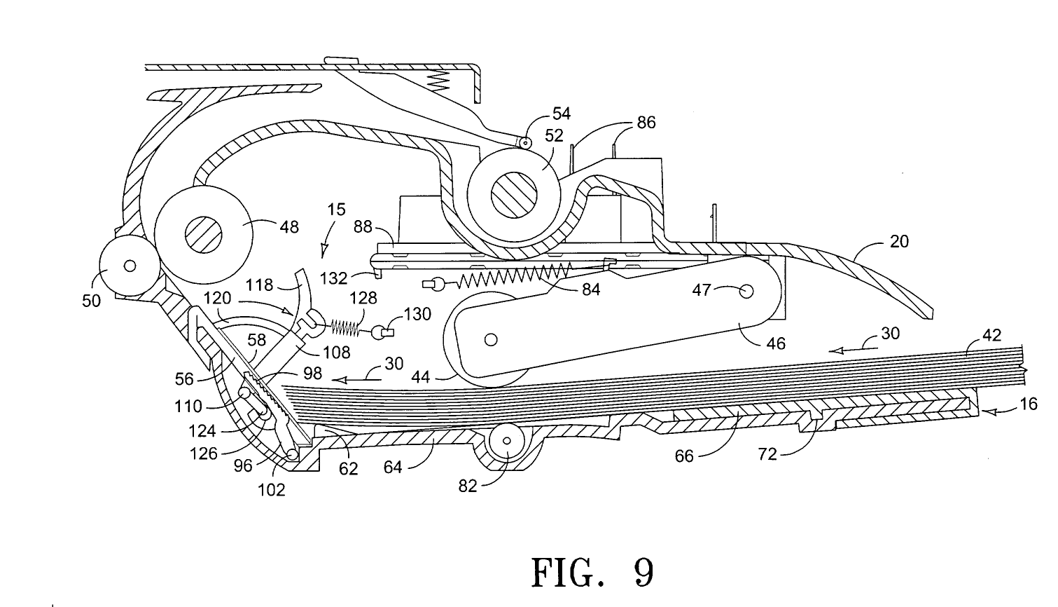

Lever arm upper part 118 is pushed rearward by wiper sled 88 and pulled forward by biasing spring 128. Linkage 106 rotates along axle 110 when lever arm upper part 118 is pushed rearward or pulled forward to move the end 124 of connecting arm 112 forward and rearward, respectively. As best seen by comparing FIGS. 8 and 9, connecting arm end 124 bears on load stop 96 to pivot load stop 96 forward on axle 102 when lever arm 108 is pushed rearward and to pivot load stop 96 rearward when lever arm 108 is pulled forward. When connecting arm end 124 is up and forward, it bears against the back of load stop face 98 to pivot load stop face 98 forward/clockwise. When connecting arm end 124 is down and rearward, it bears against load stop body 100 at saddle 126 to pivot load stop face 98 rearward/counter-clockwise.

Referring now to FIGS. 7 and 8, printer 10 is inactive and wiper sled 88 is rearward so that wipers 86 are in their resting position. In this position, contact tab 132 on wiper sled 88 has engaged and pushed lever arm upper part 118 fully rearward to move connecting arm end 124 up and forward, pivoting load stop face 98 into media path 30. When load stop 96 is in the position shown in FIGS. 7 and 8, load stop face 98 blocks the sheets in stack 42 from being pushed too far into printer 10.

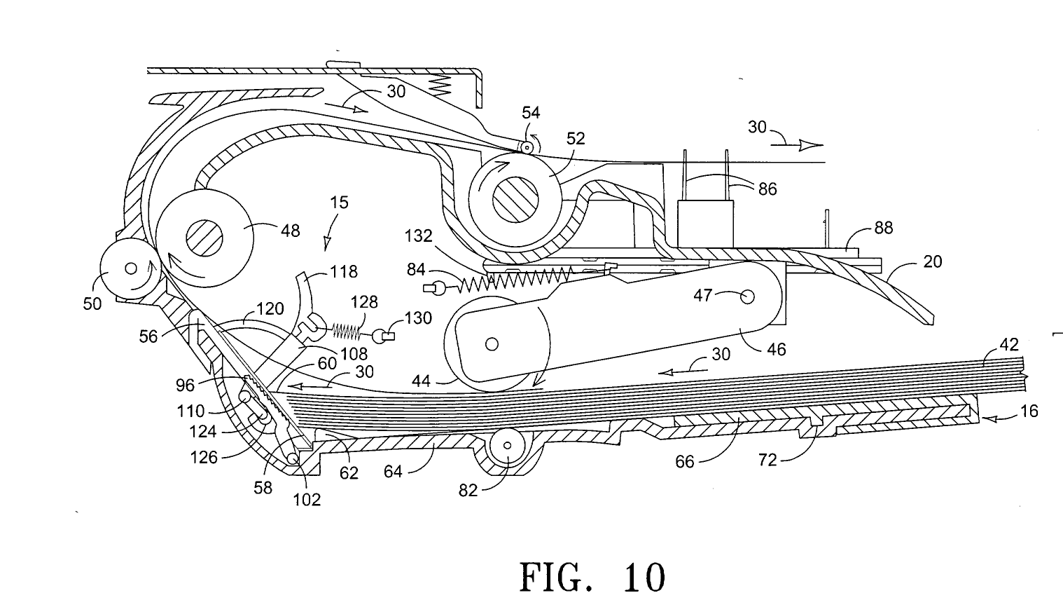

Referring to FIG. 9, which shows printer 10 at the beginning of a printing operation, wiper sled 88 has been driven forward to carry wipers 86 across the bottom of printheads 28 (not shown). Biasing spring 128 pulls lever arm upper part 118 forward to move connecting arm end 124 down and rearward into load stop saddle 126, pivoting load stop face 98 out of media path 30, as best seen by comparing FIGS. 8 and 9. Then, as shown in FIG. 10, top sheet 32 is picked from stack 42 and fed unobstructed past load stop 96 to the nip at transport roller 48. At the end of the printing operation, wiper sled 88 is driven back to the wiper resting position to pivot load stop face 98 forward back into media path 30, as shown in FIG. 7.

In a preferred configuration shown in FIGS. 5-10, wiper sled 88 is used to move load stop 96 into the blocking position, rather than biasing spring 128. As shown in FIG. 10, when a stack 42 is present in tray 16, next-to-top sheet 60 and sometimes several next to top sheets will be drawn into contact with separator pad 58. Load stop 96 must be able push these sheets away from separator pad 58 as it is moved into the blocking position. Hence, the larger force available from wiper sled 88 is used to push load stop 96 into the blocking position. The smaller force of biasing spring 128 is used to return load stop 96 to the retracted position. The constant pressure of a biasing spring strong enough to push load stop 96 into the blocking position could easily deform components of linkage 106 that would otherwise be structurally stable.

In a preferred configuration, shown in FIG. 11, load stop face 98 is constructed as a series of steps 138 to better block sheets in stack 42. The riser 140 of each step 138 is, preferably, oriented perpendicular to or angled slightly toward stack 42 to provide more positive contact with sheets at any stack height. This preferred configuration helps assure that media loaded over an already loaded stack will also be blocked.

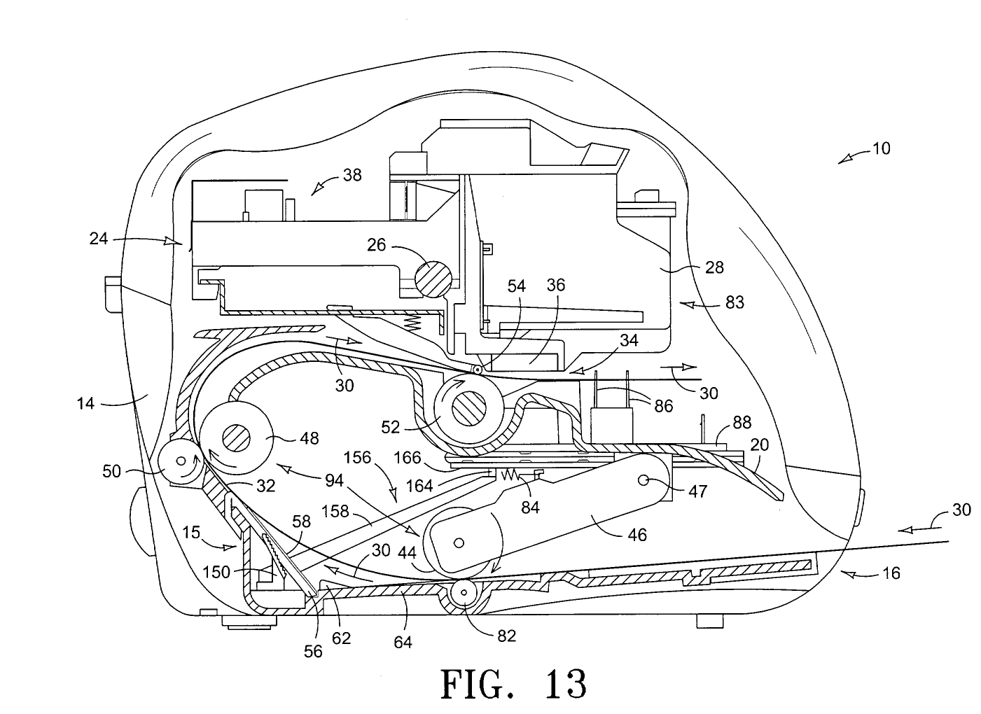

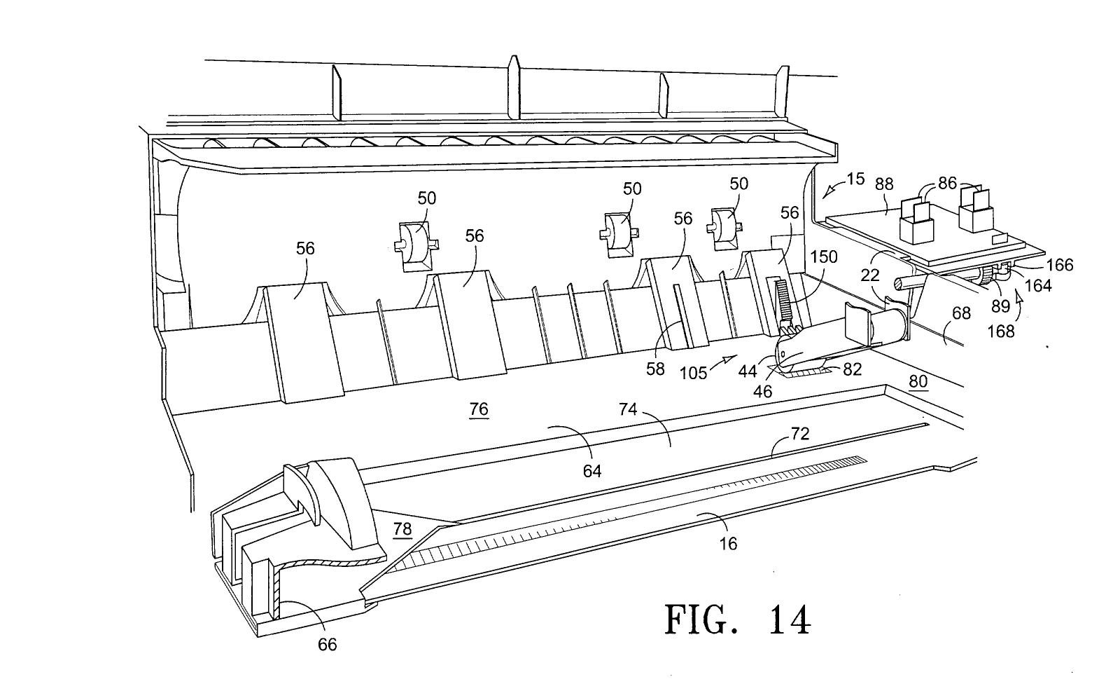

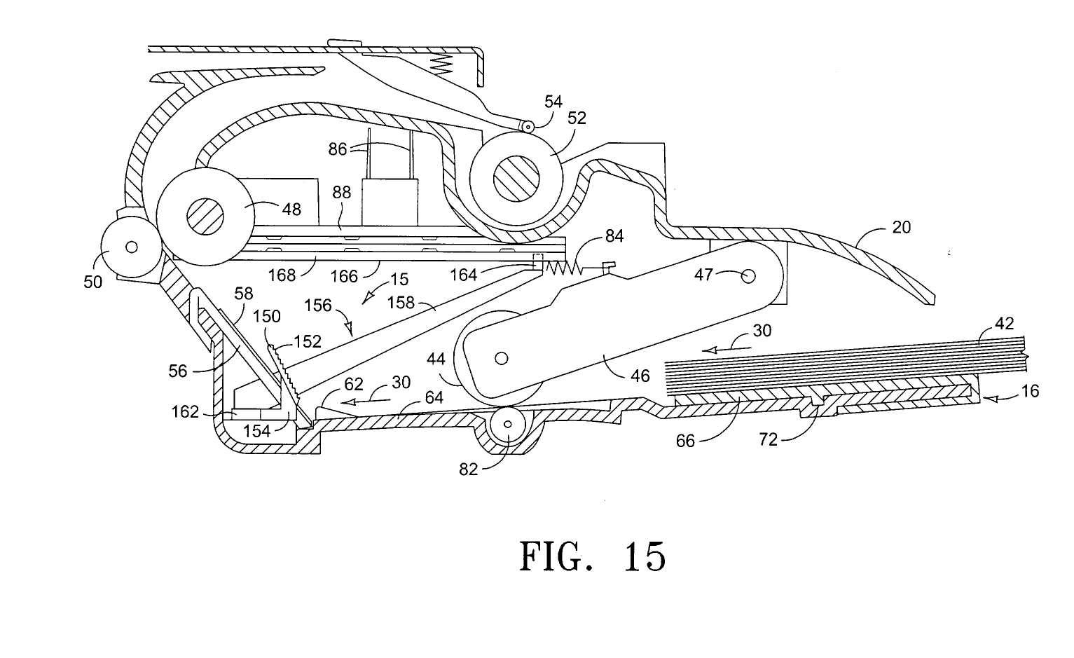

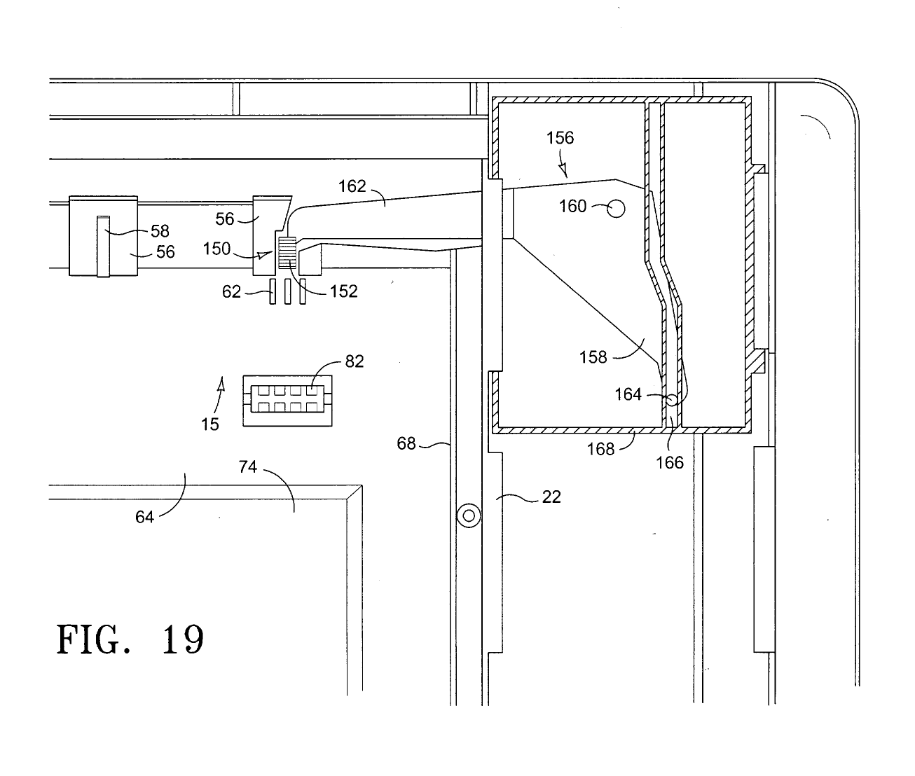

A second embodiment of the invention will now be described with reference to FIGS. 13-21. FIG. 13 is a side elevation and partial section view of a printer 10 incorporating an input structure 15 constructed according to the second embodiment of the invention. FIG. 14 is perspective view of input structure 15 and components of media sheet pick/feed mechanism 94 (FIG. 13). FIGS. 15-18 are side elevation and partial section views showing the operation of input structure 15. FIGS. 19-20 and 21 are detail plan and perspective views, respectively, of the load stop feature, actuator and linkage of the input structure 15 depicted in FIGS. 13-18.

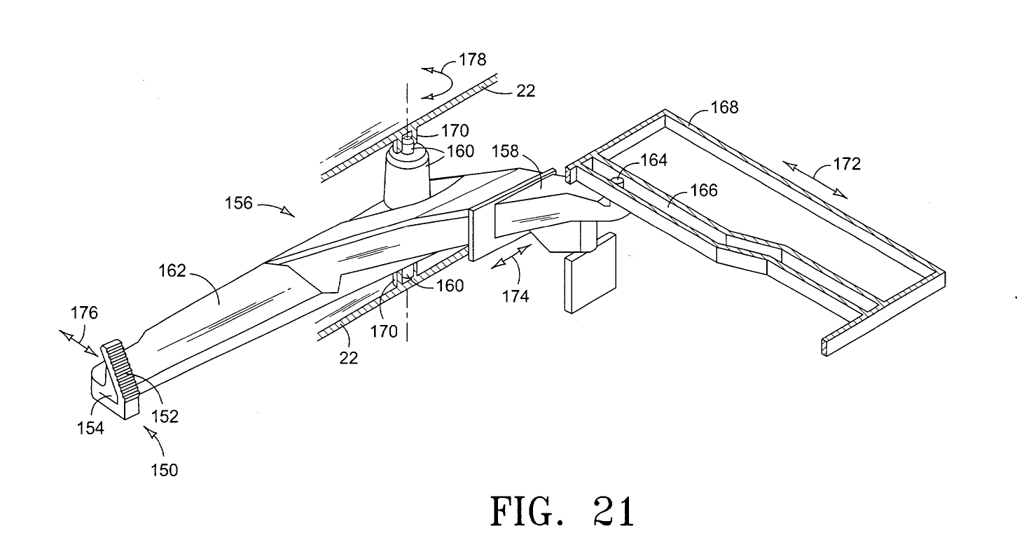

Referring to FIGS. 13-15 and 19-21, input structure 15 includes media tray 16, ramps/walls 56, separator pad 58 and a load stop 150. Load stop 150 is housed in one of the guide ramps 56. Load stop 150 includes a face 152 and a body 154. A linkage 156 connects load stop 150 to an actuator which, in this embodiment, is wiper sled 88. As best seen in FIGS. 19-21, linkage 156 includes a lever arm 158, a vertically oriented axle 160 and a connecting arm 162. Lever arm 158 extends from axle 160 to wiper sled 88. A pin/follower 164 projects up from lever arm 158 into a track 166 formed in an undercarriage 168 of wiper sled 88. In the embodiment shown, load stop 150 and linkage 156 are integrated with one another, as a single molded plastic part for example. Axle 160 is supported at each end in a hub 170 (FIG. 21) formed in or affixed to chassis 22 below the rear travel area of wiper sled 88. Connecting arm 162 extends from axle 160 to load stop 150.

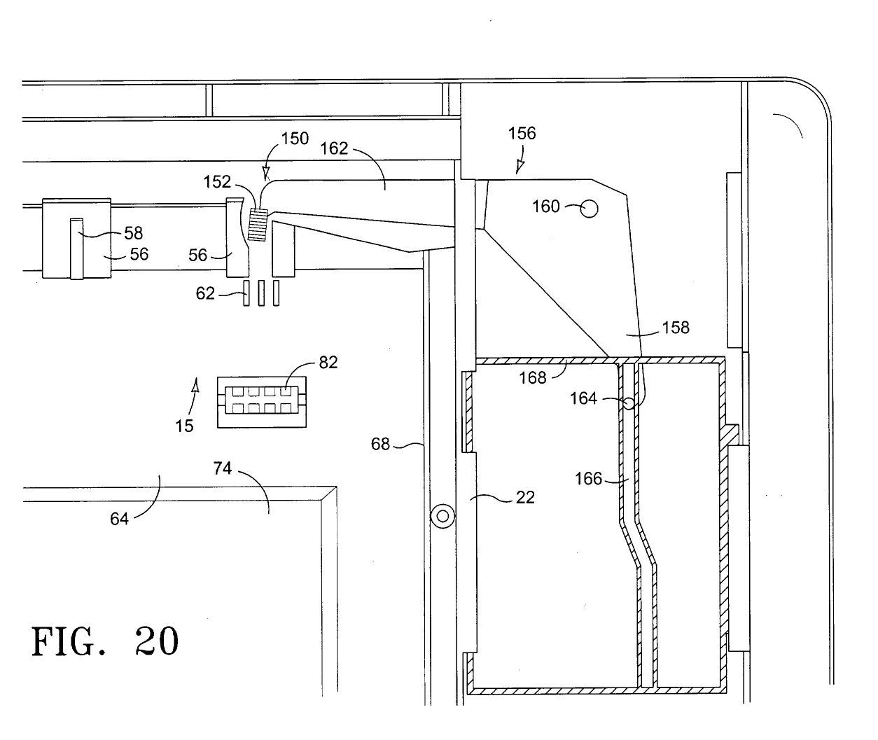

Referring to FIGS. 19-21, lever arm 158 moves back and forth as wiper sled 88 moves forward and rearward at the urging of pin/follower 164 riding in track 166. Linkage 156 rotates on axle 160 when lever arm 158 moves back and forth to move connecting arm 162, which carries load stop 150, forward and rearward. The forward and rearward motion of wiper sled 88, and connecting arm 162 and load stop 150 is indicated by direction arrows 172 and 176, respectively, and the side to side motion of lever arm 158 is indicated by direction arrow 174 in FIG. 21. The rotation of linkage 156 on axle 160 is indicated by direction arrow 178 in FIG. 21. When wiper sled 88 moves forward, lever arm 158 is pushed to the left to rotate connecting arm 162 clockwise and move load stop 150 rearward out of the blocking position shown in FIG. 19 to the retracted position shown in FIG. 20. When wiper sled 88 moves rearward, lever arm 158 is pushed back to the right to rotate connecting arm 162 counter-clockwise and move load stop 150 forward back into the blocking position shown in FIG. 19.

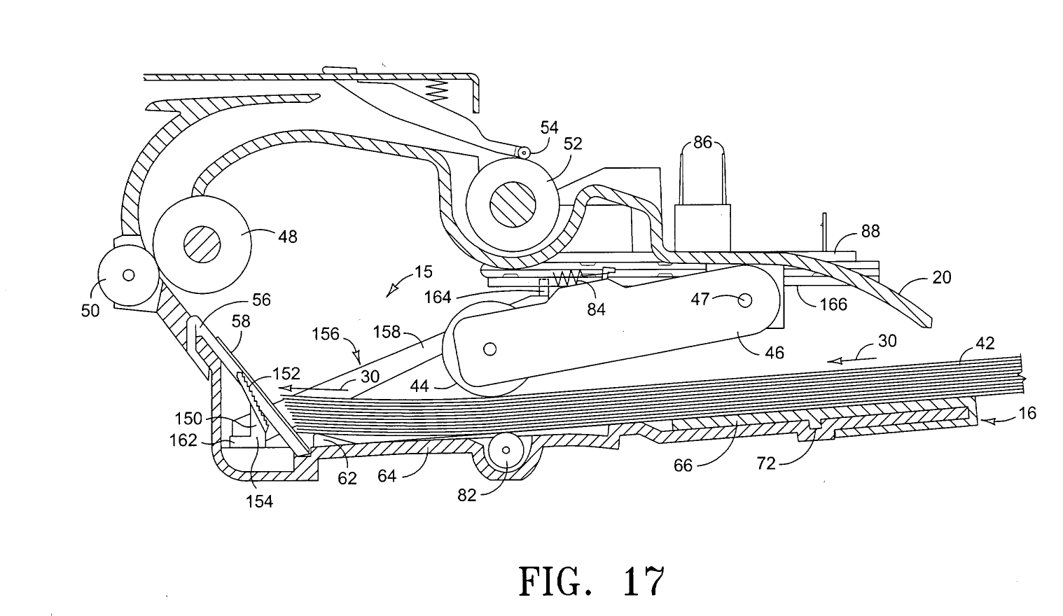

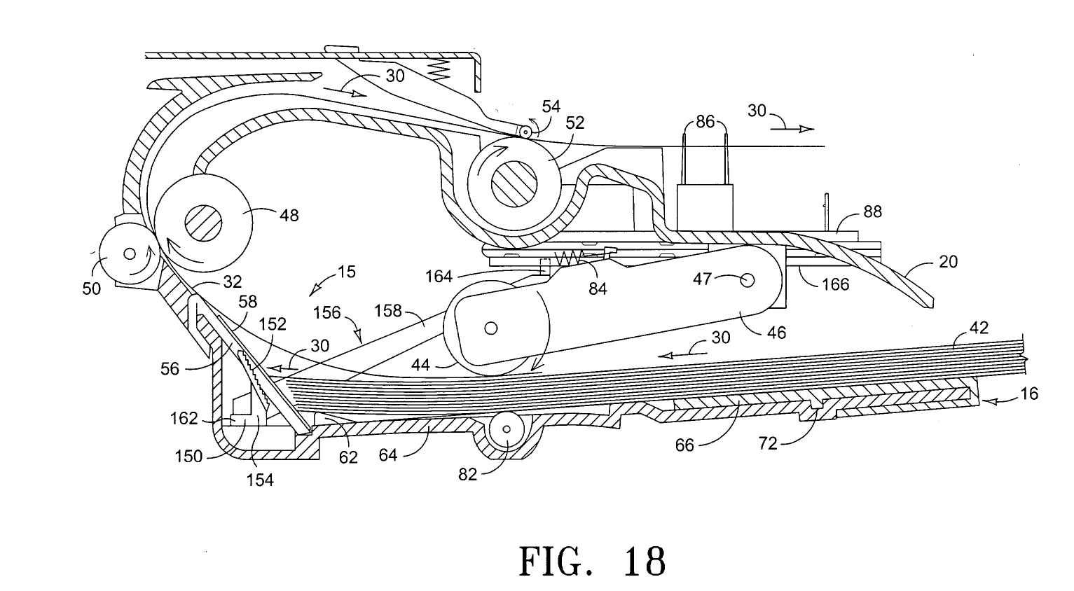

Referring now to FIGS. 15-16 and 18, printer 10 is inactive and wiper sled 88 is rearward so that wipers 86 are in their resting position. In this position, sled track 166 has pushed pin/follower 164 and lever arm 158 to the right, rotating connecting arm 162 and load stop 150 forward so that load stop face 152 blocks media path 30. Referring to FIGS. 17 and 20, which show printer 10 at the beginning of a printing operation, wiper sled 88 has been driven forward to carry wipers 86 across the bottom of printheads 28 (not shown) and push pin/follower 164 and lever arm 158 to the left, rotating connecting arm 162 and load stop 150 rearward so that load stop face 152 is retracted out of media path 30. Then, as shown in FIG. 18, top sheet 32 is picked from stack 42 and fed unobstructed past load stop 150 to the nip at transport roller 48. At the end of the printing operation, wiper sled 88 is driven back to the resting position to rotate load stop face 152 forward back into media path 30, as shown in FIG. 15.

The exemplary embodiments shown in the figures and described above illustrate but do not limit the invention. Sled 88 is just one example of a suitable actuator for the load stop. In some printers or other sheet media processing devices, another driven component could actuate the load stop, or a discrete drive mechanism dedicated to moving the load stop could be used. For input structures that utilize angled guide ramps or separation walls at the front of the media tray, such as the input structure shown in the figures, it is expected that the load stop will usually be housed in one of the guide ramps. In the embodiments shown in the figures, load stops 96 and 150 are housed in the guide ramp 56 located at the far right of input structure 15, closest to wiper sled 88, to make linkages 106 and 156 as short as possible. If a different actuator is used and, correspondingly, a different linkage is needed between the actuator and the load stop, then the load stop could be housed in a different guide ramp or at a location removed from the guide ramps. These and other forms, details, modification and embodiments may be made and implemented. Hence, the foregoing description should not be construed to limit the spirit and scope of the invention, which is defined in the following claims.

What is claimed is:

1. A sheet media input structure for a sheet media processing device, comprising:
a sheet media supporting surface;
a first feature downstream from the supporting surface along a media path that extends from the supporting surface to and along the first feature, the first feature configured to separate a top sheet on the stack from a next-to-top sheet in the stack; and
a second feature positioned near the first feature, the second feature movable between a first position blocking the media path between the supporting surface and the first feature and a second position not blocking the media path between the supporting surface and the first feature.

2. The structure of claim 1, wherein the second feature is pivotable between the first position and the second position.

3. The structure of claim 1, wherein the second feature is rotatable in a plane between the first position and the second position.

4. The structure of claim 1, wherein the first feature comprises a ramp oriented at an obtuse angle relative to the supporting surface.

5. The structure of claim 1, wherein the first feature comprises an elastomeric strip oriented at an obtuse angle relative to the supporting surface.

6. The structure of claim 1, wherein the first feature comprises a ramp oriented at an obtuse angle relative to the supporting surface and an elastomeric strip extending along the ramp.

7. A sheet media input structure for a sheet media processing device, comprising:
a sheet media supporting surface; and
a movable face positioned downstream along a media path from the supporting surface, the face movable between a first position in which the face protrudes into the media path to block a leading edge of media sheets supported on the supporting surface and a second position in which the face does not protrude into the media path and media sheets are free to move from the supporting surface along the media path past the face.

8. The structure of claim 7, wherein the face is oriented at an obtuse angle relative to the supporting surface.

9. The structure of claim 7, wherein the face comprises a stepped face.

10. The structure of claim 9, wherein a riser of each step on the face is oriented at an angle of 90° or less relative to the supporting surface.

11. A sheet media input structure for a sheet media processing device, comprising:
a sheet media supporting surface;
a ramp positioned downstream along a media path from the supporting surface, the ramp oriented at an obtuse angle relative to the supporting surface; and
a movable face positioned near the ramp, the face movable between a first position in which the face protrudes into the media path upstream from the ramp to block a leading edge of media sheets supported on the supporting surface and a second position in which the face does not protrude into the media path and media sheets are free to move from the supporting surface along the media path up the ramp.

12. The structure of claim 11, further comprising an actuator operatively coupled to the face to pivot the face between the first position and the second position.

13. The structure of claim 11, further comprising an actuator operatively coupled to the face to rotate the face in a plane between the first position and the second position.

14. The structure of claim 11, wherein the face is oriented at an obtuse angle relative to the supporting surface.

15. The structure of claim 11, wherein the face comprises a stepped face.

16. The structure of claim 15, wherein a riser of each step on the face is oriented at an angle of 90° or less relative to the supporting surface.

17. A sheet media input structure for a sheet media processing device, comprising:
a media tray configured to hold a stack of media sheets in an input position for feeding into the device;
a first stationary obstacle in front of the tray, the first obstacle configured to impede but not block a leading edge of media sheets fed from the tray into the device; and
a second movable obstacle in front of the tray, the second obstacle movable between a first position blocking media sheets in the tray and a second position not blocking media sheets in the tray.

18. The structure of claim 17, wherein the second obstacle is pivotable on an axis and the structure further comprising:
an actuator; and
a linkage connecting the actuator and the second obstacle, the linkage configured to pivot the second obstacle between the first position and the second position in response to translational motion of the actuator.

19. The structure of claim 17, further comprising:
an actuator; and
a linkage operatively connected between the actuator and the second obstacle, the linkage configured to rotate the second obstacle in a plane between the first position and the second position in response to translational motion of the actuator.

20. The structure of claim 18, wherein the linkage comprises:
a lever arm operatively connected to the actuator;
a connecting arm operatively connected to the second obstacle; and
an axle joining the lever arm and the connecting arm, the axle defining an axis about which the lever arm and the connecting arm rotate in response to translational motion of the actuator acting on the lever arm.

21. The structure of claim 19, wherein the linkage comprises:
a lever arm operatively connected to the actuator;
a connecting arm operatively connected to the second obstacle; and
an axle joining the lever arm and the connecting arm, the axle defining an axis about which the lever arm and the connecting arm rotate in response to translational motion of the actuator acting on the lever arm.

22. The structure of claim 21, wherein:
the actuator includes a track having a first run and a second run parallel to and off-set from the first run; and
the lever arm includes a follower that rides in the track such that, when the actuator translates, the follower follows the first run of track to the second run of track or the second run of track to the first run of track to rotate the lever arm and the connecting arm on the axle about the axis and thereby rotate the second obstacle in a plane between the first position and the second position.

23. A printer, comprising:
a print engine;
a sheet media input structure;
a pick/feed mechanism operative to move media sheets from the input structure to the print engine along a media path;
a printer controller configured to control the operation of the print engine and the pick/feed mechanism;
the input structure including a sheet media supporting surface and a movable face positioned downstream along the media path from the supporting surface, the face movable between a first position in which the face protrudes into the media path to block a leading edge of media sheets supported on the supporting surface and a second position in which the face does not protrude into the media path and media sheets are free to move from the supporting surface along the media path past the face.

24. A printer, comprising:
a print engine;
a sheet media input structure;
a pick/feed mechanism operative to move media sheets from the input structure to the print engine along a media path;
a printer controller configured to control the operation of the print engine and the pick/feed mechanism;
the input structure including
a media tray configured to hold a stack of media sheets in an input position for feeding into the print engine;
a first stationary obstacle in front of the tray, the first obstacle configured to impede but not block a leading edge of media sheets fed from the tray into the print engine; and
a second movable obstacle in front of the tray, the second obstacle movable between a first position blocking media sheets in the tray and a second position not blocking media sheets in the tray.

25. An inkjet printer, comprising:
a print engine that includes multiple printheads and a carriage operative to carry the printheads back and forth across a portion of a media path;
a sheet media input structure;
a pick/feed mechanism operative to move media sheets from the input structure to the print engine along the media path;
a printhead service station that includes multiple wipers and a sled operative to carry the wipers parallel to the media path back and forth across a surface of the printheads;
a printer controller configured to control the operation of the print engine, the pick/feed mechanism and the service station;
the input structure including
a media tray configured to hold a stack of media sheets in an input position for feeding into the print engine;
a first stationary obstacle in front of the tray, the first obstacle configured to impede but not block a leading edge of media sheets fed from the tray toward the print engine;
a second movable obstacle in front of the tray, the second obstacle movable between a first position blocking media sheets in the tray and a second position not blocking media sheets in the tray; and
a linkage operatively connected between the wiper sled and the second obstacle, the linkage configured to move the second obstacle between the first position and the second position in response to movement of the wiper sled.

26. The inkjet printer of claim 25, wherein the linkage is configured to pivot the second obstacle between the first position and the second position in response to movement of the wiper sled.

27. The inkjet printer of claim 25, wherein the linkage is configured to rotate the second obstacle in a plane between the first position and the second position in response to movement of the wiper sled.

28. A sheet media input structure for a sheet media processing device, comprising:
a supporting means for supporting sheet media;
a separating means positioned downstream from the supporting means along a media path that extends from the supporting means to and along the separating means, the separating means for separating a top sheet on a stack of sheets supported on the supporting means from a next-to-top sheet in the stack;
a blocking means positioned near the separating means for blocking the media path; and
a moving means for moving the blocking means between a first position blocking the media path and a second position not blocking the media path.

29. The structure of claim 28, wherein the moving means comprises a means for pivoting the blocking means between the first position and the second position.

30. The structure of claim 28, wherein the moving means comprises a means for rotating the blocking means in a plane between the first position and the second position.

31. In a sheet media processing device having a sheet media input tray and a media path extending from the input tray, a method comprising alternately blocking and unblocking the media path.

32. In an inkjet printer having a printhead, a sheet media input tray and a media path extending from the input tray to the printhead, a method comprising wiping the printhead and simultaneously blocking the media path and then wiping the printhead again and simultaneously unblocking the media path.
